(19) United States
(12) Patent Application Publication
(10) Pub. No.: US 2023/0327476 A1
(43) Pub. Date: Oct. 12, 2023

(54) BATTERY MANAGEMENT SYSTEM

(71) Applicant: Apple Inc., Cupertino, CA (US)

(72) Inventor: Fletcher R. Rothkopf, Los Altos, CA (US)

(21) Appl. No.: 18/187,062

(22) Filed: Mar. 21, 2023

Related U.S. Application Data
(63) Continuation of application No. PCT/US2021/071268, filed on Aug. 24, 2021.
(60) Provisional application No. 63/081,799, filed on Sep. 22, 2020.

(51) Int. Cl. H02J 7/34; H02J 7/00

(52) U.S. Cl. CPC H02J 7/342; H02J 7/0068; H02J 7/0048; H02J 7/0069; H02J 7/0013

(57) ABSTRACT

A battery management system for minimizing battery degradation. The system including an electronic device with a primary battery, an auxiliary battery configured to power the electronic device, a processor in communication with the electronic device and operable to monitor a state of charge of the primary battery and a state of charge of the auxiliary battery, a charging station in communication with the processor and operable to modulate a charge based on at least one of the state of charge of the primary battery, the state of charge of the auxiliary battery, or a usage of the electronic device.

### CROSS-REFERENCE TO RELATED APPLICATION(S)

This is a continuation of International Patent Application No. PCT/US2021/071268, filed 24 Aug. 2021, and entitled “BATTERY MANAGEMENT SYSTEM,” which claims priority to U.S. Provisional Patent Application No. 63/081,799, filed 22 Sep. 2020, and entitled “BATTERY MANAGEMENT SYSTEM,” the entire disclosures of which are hereby incorporated by reference.

### FIELD

The described embodiments relate generally to battery management systems. More particularly, the present embodiments relate to battery management systems for electronic devices using multiple batteries.

### BACKGROUND

Rechargeable batteries have become ubiquitous in portable electronic devices. Today's most prolific battery technologies, such as lithium-ion polymer (LiPo) batteries, have limited lifetimes due to battery degradation. Several factors can affect the performance and lifetime of a battery, including the mode and frequency of charging, as well as the duration spent at specific states of the battery's charge. Accordingly, a need exists for battery systems that can minimize battery degradation and maximizing usability with one or more electronic devices.

### SUMMARY

According to some aspects of the present disclosure, a battery management system includes an electronic device including a primary battery, an auxiliary battery that is electrically couplable with the electronic device, and a charging station. The charging station can include a power supply, a receiving element to receive and electrically couple with at least one of the primary battery or the auxiliary battery, and an electronic communication unit to communicate with the electronic device. The charging station can modulate a state of charge of at least one of the primary battery or the auxiliary battery based on at least one of the state of charge of the primary battery, the state of charge of the auxiliary battery, or a usage of the electronic device.

In some examples, the electronic device is a head-mounted display including a housing defining an internal volume, a processor disposed in the internal volume and in communication with the charging station, the processor operable to monitor the state of charge of the primary battery and the state of charge of the auxiliary battery. The primary battery can be a fixed battery disposed in the internal volume, and the auxiliary battery can be removably attachable to the electronic device.

In some examples, the processor maximizes a duration that the primary battery has a desired state of charge by modulating the state of charge of the primary battery and the state of charge of the auxiliary battery. A desired stated of charge can be between 20% and 80%. The processor can modulate the state of charge of the primary battery by causing the primary battery to power the electronic device in response to the primary battery exceeding the desired state of charge. The processor can modulate the state of charge of the auxiliary battery by causing the auxiliary battery to power the electronic device in response to the auxiliary battery having the desired state of charge.

In some examples, the usage of the electronic device includes at least one of a calendar event, a location of the electronic device, a power consumption, a proximity of the auxiliary battery, a time of day, or a date. The auxiliary battery can be a first auxiliary battery and the battery management system can further include a second auxiliary battery, the second auxiliary battery electrically couplable with the electronic device to power the electronic device, charge the primary battery, and charge the auxiliary battery. The primary battery can charge the auxiliary battery when the auxiliary battery and the primary battery are electrically coupled with the electronic device. The auxiliary battery can power the electronic device in response to the electronic device being in a high power mode. The charging station can modulate a rate of charge of the auxiliary battery based on a rate of discharge of primary battery when the primary battery is electrically coupled with the electronic device. The charging station can prioritize a rapid charge of the auxiliary battery over a rapid charge of the primary battery.

According to some aspects, a battery management system includes an auxiliary battery electrically couplable with an electronic device including a primary battery. The battery management system can further include a charging station including a receiving element to receive and electrically couple with the auxiliary battery, and an electronic communication unit to communicate with the electronic device. The charging station can modulate a state of charge of the auxiliary battery based on at least one of a state of charge of the primary battery, a state of charge of the auxiliary battery, or a usage of the electronic device.

In some examples, the charging station transmits a signal to the electronic device corresponding to the state of charge of the auxiliary battery. The charging station can maintain the state of charge of the auxiliary battery in a desired range when the auxiliary battery is electrically coupled with the charging station. The electronic device can be electrically couplable with the charging station and the state of charge of the primary battery can be modulated by the charging station.

According to some aspects, a head-mounted display includes a mounting component to mount the head-mounted display to a head of a user, a housing defining an internal volume, a display component, an external-facing sensor, an electronic communication unit to communicate with a charging station, a primary battery, and a processor disposed in the internal volume. The processor can modulate a state of charge of the primary battery and a state of charge of an auxiliary battery electrically coupled with the charging station, based on at least one of the state of charge of the primary battery, the state of charge of the auxiliary battery, or a usage of the head-mounted display

In some examples, the head-mounted display further includes a receiving element to receive and electrically couple with the auxiliary battery. The primary battery can be removably receivable by the receiving element. The usage of the head-mounted display can include at least one of a calendar event, a location of the head-mounted display, a current power consumption, a typical power consumption, a proximity of the auxiliary battery, a time of day, or a date.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a block diagram of a battery management system.

FIG. 2 shows a block diagram of a battery management system.

FIG. 3 shows a process flow diagram of a battery management system.

FIG. 4 shows a process flow diagram of a battery management system.

FIG. 5 shows a process flow diagram of a battery management system.

FIG. 6 shows a block diagram of a battery management system.

FIG. 7 shows a block diagram of a battery management system.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to battery management systems that can be incorporated on multi-battery systems to increase battery life and reduce battery degradation. Rechargeable batteries have become ubiquitous in portable electronic devices. Today's most prolific battery technologies, such as lithium-ion polymer (LiPo) batteries, however, have limited lifetimes. A typical battery may experience 1,000 full charge/discharge cycles before degrading to less than 80% of its original performance. Additionally, several factors can affect the performance of the battery, such as temperature, state of charge (SoC), and rates of charging and consumption.

Charge/discharge cycles can have varying effects on degradation of the battery. The transfer or shuttling of lithium metal and lithium ions between the electrodes in lithium-ion batteries is a slow process. Therefore, charging at lower rates allows more complete shuttling to occur, which enhances the battery's charge capacity. For example, battery degradation can be accelerated by higher (i.e., more rapid) discharge rates, higher charge rates, the temperature, and the duration of a high or low state of charge.

Several measures have traditionally been taken in attempts to combat battery degradation, including: timed charging that factors user behavior to reduce the time spent at near 100% SoC; thermal monitoring that waits until batteries cool down to begin, or continue, charging; and manually or automatically limiting the maximum SoC when longest possible battery life is not required.

As described herein, various processes can be performed by a multi-battery management system to improve the efficiency and longevity of the batteries, as well as to provide devices with batteries having an optimized SoC to, for example, increase the amount of time a user can operate such a device. In some examples, the battery management system can include a charging station and one or more auxiliary batteries. In some examples, the battery management system can include one or more electronic devices. For example, the battery management system can include an electronic device, such as a smartphone, a charging station, and one or more auxiliary batteries. According to one example, a primary or fixed battery is housed in an electronic device. At least one auxiliary battery can be electrically and removably coupled to or with the electronic device to provide power to the electronic device and/or the primary battery. The auxiliary battery can electrically couple with the charging station (also referred to herein as a smart charger). The smart charger can charge or discharge the auxiliary battery and the primary battery. A state of charge of the primary battery in the electronic device, and a state of charge of the auxiliary battery can be monitored by a processor of the device, the smart charger, or both. Based on the monitored states of charge, the battery management system can modulate its operation to improve battery efficiency and reduce degradation in one or more batteries. For example, the battery management system can modulate operation by selecting a certain battery to power the device or by selecting a certain battery for charging/discharging by the smart charger. Further, the smart charger can modulate the rate of charging/discharging to reduce battery degradation.

The system can select which battery to power the device based on the monitored states of charge. The decision can be based on a desire to operate and maintain one or more of the batteries in a desired range or zone. For example, the desired state of charge can be a range in which the battery experiences minimal degradation while still being able to power the device. For example, a desired state of charge of the batteries can be between 10% and 90%, between 20% and 80%, or between 30% and 70%. According to one example, if the primary battery has a relatively low state of charge (e.g., 20%), the auxiliary battery can be selected to power the device to avoid causing the primary battery from operating outside of a desired zone. According to another example, if the primary battery has a relatively high state of charge (e.g., 100%) and the auxiliary battery has a desired state of charge (e.g., 60%), the primary battery can be selected to power the device to obtain a desired state of charge in the primary battery and maintain the desired state of charge in the auxiliary battery. In some examples, the processor can prioritize the health of the primary battery over that of the auxiliary battery. In some examples, the primary battery may have a full state of charge (e.g., 100%) and the device can be plugged in. In this example, the processor can select the primary battery to power the device to reduce trickle charging and degradation of the primary battery. In some examples, the default can be to power the device using the auxiliary battery to avoid degradation of the primary battery.

Further, powering of the device can be based on the power demands of the device. If, for example, the device is in a high power mode (i.e., requiring a large amount of power), the device can be programmed to use the auxiliary battery to power the device. In some examples, the user can select which battery to use. Multiple batteries can be selected to simultaneously power the device. In some examples, the power requirements of the device can be evenly split between the batteries. In some examples, the power requirements of the device are unevenly divided between the available batteries.

In some examples, the auxiliary battery can be used to charge the primary battery. For example, the primary battery may have a state of charge outside of the desired zone (e.g., 5%). In response, the auxiliary battery can charge the primary battery to raise the state of charge back into the desired zone (e.g., 80%) or above. In some examples, the device can instruct the auxiliary battery to continuously charge the primary battery.

Charging by the smart charger can also be modulated based on several factors in an attempt to minimize battery degradation by maintaining a desired state of charge in one or more of the batteries. In some examples, the auxiliary battery can be charged or discharged by the smart charger based on a state of charge of the primary battery. The auxiliary battery can be charged or discharged based on its own state of charge. The auxiliary battery can be charged or discharged by the smart charger based on a usage of the device. For example, the auxiliary battery can be dynamically charged by the smart charger based on past, current, or predicted uses of the device. In some examples, the device can learn the user's habits and can make predictions of upcoming power needs based on the learned habits. In some examples, the auxiliary battery can be dynamically charged based on a power mode of the device or required power consumption of the device. In some examples, the auxiliary battery can be dynamically charged based on an upcoming calendar event, email content, or set timers. In some examples, the auxiliary battery can be dynamically charged based on the date or time.

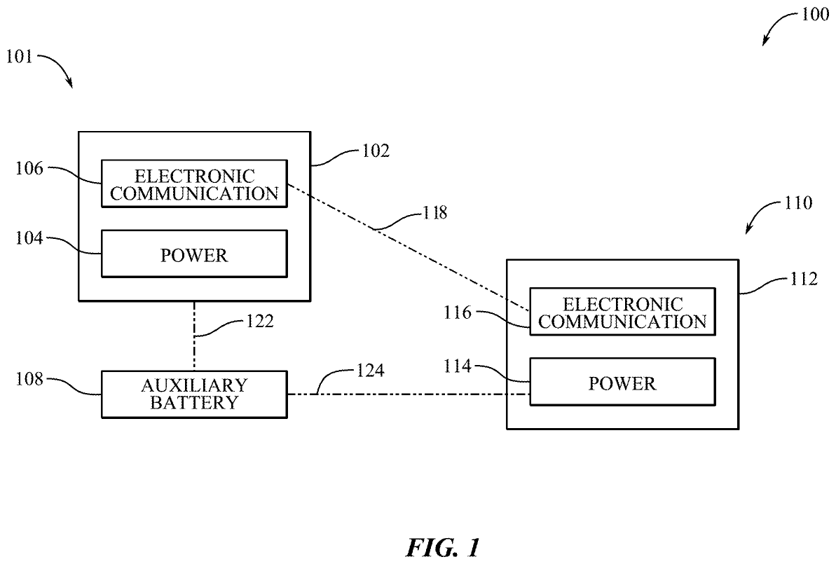

These and other embodiments are discussed below with reference to FIGS. 1-7. However, those skilled in the art will readily appreciate that the detailed description given herein with respect to these Figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 shows a block diagram of a battery management system 100. The system 100 can include an electronic device 101, an auxiliary battery 108, and a charging station 110. The electronic device 101 can be a portable electronic device such as a smartphone, laptop, wearable device, including a head-mounted display or smart glasses, or any other electronic device. The electronic device 101 can include a housing 102, a power supply unit 104, and an electronic communication unit 106. The housing 102 can be a physical structure that at least partially defines an internal volume. The housing can incorporate, contain, or connect to the power supply unit 104 and the electronic communication unit 106, and the power supply unit and the electronic communication unit can be disposed in the internal volume defined by the housing 102. Although FIG. 1 shows the housing 102 as a single unit, multiple operatively connected housing units can be used.

The power supply unit 104 can be operative to supply power to the electronic device 101. In some examples, the power supply unit 104 can be a rechargeable battery, such as a lithium polymer (LiPo) battery. The power supply unit 104 can be referred to as a primary battery or a fixed battery. The primary battery 104 can be designed to reside permanently in the electronic device 101. Although FIG. 1 shows the power supply unit 104 as a single unit, multiple power supply units can be used.

In some examples, the power supply unit 104 can include a receiving element to receive and electrically couple the electronic device 101 with a battery, such as a primary battery or the auxiliary battery 108. The receiving element can be configured to removably couple the electronic device 101 with the battery. In some examples, the receiving element can include attachment features that are incorporated into the housing 102 of the electronic device 101. The receiving element can be configured as a terminal, recess, slot, latch, groove, notch, magnet, or other feature capable of securing and electrically coupling a battery with the electronic device 101. In some examples, the receiving element includes an electrical connection such as a wire that connects to a battery without requiring the battery to be attached to, or be in direct contact with, the electronic device 101. For example, the auxiliary battery 108 can be electrically coupled to the electronic device 101 via a wire, such that the user could place the auxiliary battery 108 in a clothing pocket or backpack while possessing the electronic device 101.

The electronic communication unit 106 can communicate (i.e., receive and transmit) data with one or more external devices or systems, such as charging station 110, using one or more wired or wireless electronic communication protocols, such as a radio waves, an 802.11 electronic communication protocol, a Bluetooth electronic communication protocol, a near-field communication (NFC) electronic communication protocol, or the like. Although FIG. 1 shows the electronic communication unit 116 as a single unit, multiple electronic communication units can be used.

The charging station 110 can be a charger, such as a smart charger or microprocessor controlled charger. The charging station 110 can include a housing 112, a power supply unit 114, and an electronic communication unit 116. The housing 112 can be a physical structure that at least partially defines an internal volume. The housing can incorporate, contain, or connect to the power supply unit 114 and the electronic communication unit 116 and the power supply unit and the electronic communication unit can be disposed in the internal volume defined by the housing. As discussed in greater detail below, the charging station 110 can include attachment mechanisms to electrically couple with the auxiliary battery 108 and the electronic device 101.

In some examples, the power supply unit 114 can include a receiving element to receive and electrically couple the power supply unit 114 with a battery, such as the primary battery 104 or the auxiliary battery 108. The receiving element can be configured to removably couple the charging station 110 with a battery. In some examples, the receiving element can include attachment features that are incorporated into the housing 112 of the charging station 110. The receiving element can be configured as a terminal, recess, slot, latch, groove, notch, magnet or other feature capable of securing and electrically coupling a battery with the power supply unit 114 of the charging station 110. In some examples, the receiving element includes an electrical connection such as a wire that connects to a battery without requiring the battery to be attached to, or in direct contact with, the housing 112 of the charging station 110.

In some examples, the charging station 110 charges the auxiliary battery 108 via inductive charging. In some examples, the charging station 110 can make a physical connection with the auxiliary battery 108 to charge the auxiliary battery 108. The auxiliary battery 108 can provide wired or wireless power transfer to the electronic device 101. The power supply unit 114 can be operative to supply power to the charging station 110. In some examples, the power supply unit 114 can be an external power supply, such as a wall outlet.

The charging station 110 can communicate with the electronic device 101 via communications link 118. The electronic communication unit 106 can communicate (i.e., receive and transmit) data with one or more external devices or systems, such as electronic device 101, using one or more wired or wireless electronic communication protocols, such as a radio waves, an 802.11 electronic communication protocol, a Bluetooth electronic communication protocol, a near-field communication (NFC) electronic communication protocol, or the like. Although FIG. 1 shows the electronic communication unit 114 as a single unit, multiple electronic communication units can be used.

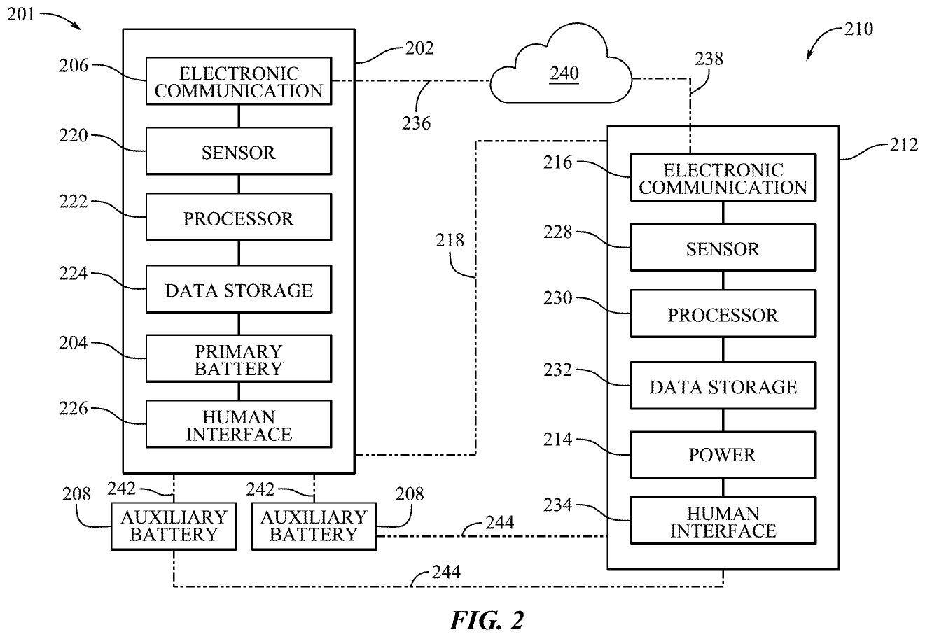

The auxiliary battery 108 can be a rechargeable battery, such as a lithium-ion polymer (LiPo) battery. It will be understood that the term battery, as used herein, relates not only to a single battery cell but also to a group of batteries used in series or parallel, or a combination of both. Further, although certain examples described herein may only refer to a single auxiliary battery, it will be understood that multiple auxiliary batteries can be used and the same methods and processes described herein can be adapted to multiple auxiliary batteries. An advantage of having at least two auxiliary batteries is the ability for continuous use of electronic device by cycling the auxiliary batteries on and off the charging station. The auxiliary battery 108 can be operatively coupled with the electronic device to provide power to the electronic device 101. In some examples, the auxiliary battery 108 can exchange a charge with the primary battery 104. The auxiliary battery 108 can be electrically couplable with the electronic device 101 via electrical coupling 122, and with the charging station 110 via electrical coupling 124. Further details regarding a system for battery management are provided below with reference to FIG. 2.

FIG. 2 shows a block diagram of a battery management system 200 including an electronic device 201, auxiliary batteries 208, and a charging station 210. The battery management system 200 can be substantially similar to, and can include some or all of the features of, the battery management system 100 discussed above. The electronic device 201 can implement one or more aspects of the methods and systems described herein. It will be understood that the electronic device 201 can include other components not shown in FIG. 2.

The electronic device 201 can include a housing 202, an electronic communication unit 206, a sensor unit 220, a processor 222, a data storage unit 224, a primary battery 204, and a human interface unit 226. The housing 202 can be a physical structure that incorporates, contains, or connects to the primary battery 204, the data storage unit 224, the processor 222, the sensor unit 220, the electronic communication unit 206, and the human interface unit 226. In some examples, one or more of the primary battery 204, the data storage unit 224, the processor 222, the sensor unit 220, the electronic communication unit 206, or the human interface unit 226 can be omitted. Although FIG. 2 shows the housing 202 as a single unit, multiple operatively connected housing units can be used.

The primary battery 204 can be operative to electrically couple with, and supply power to, the data storage unit 224, the processor 222, the sensor unit 220, the electronic communication unit 206, and/or the human interface unit 226. The primary battery 204 can be a rechargeable battery, such as a lithium-ion polymer battery. Although FIG. 1 shows the primary battery 204 as a single unit, multiple batteries can be used as the main power source of the electronic device 201.

The data storage unit 224 can be operable to store and retrieve data, including computer program instructions and other data. The data storage unit 224 can include volatile memory, such as one or more random-access memory units, operable to provide storage and retrieval of an operative data set during active operation of the electronic device 201, and the data storage unit 224 can include persistent memory, such as a hard-drive, operable to provide storage and retrieval of data during active operation and to provide storage of data in an inactive, powered down, state. In some examples, the data storage unit 224 can store learned habits of the electronic device 201.

The processor 222 can receive data, such as from the data storage unit 224, the sensor unit 220, the electronic communication unit 206, the human interface unit 226, or a combination thereof. The processor 222 is further operable to receive data from the charging station 210 or cloud service 240. The processor 222 can perform or execute computer program instructions based on the received data. For example, the processor 222 can receive and execute the computer program instructions stored on the data storage unit 224. The processor 222 is operable to output data. For example, the processor 222 can output data to the data storage unit 224, the sensor unit 220, the primary battery 204, the electronic communication unit 206, and the human interface unit 226. The processor 222 can control the primary battery 204, the data storage unit 224, the sensor unit 220, the electronic communication unit 206, and the human interface unit 226. Although FIG. 2 shows the processor 222 as a single unit, multiple data processing units can be used.

The sensor unit 220 can detect or determine one or more aspects of the operational environment or physical environment of the electronic device 201. Although only one sensor unit 220 is shown in FIG. 2, it will be understood that sensor unit 220 can include multiple physically distinct or combined sensors. For example, sensor unit 220 can include one or more of a camera, a microphone, an infrared receiver, a global positioning system unit, a gyroscopic sensor, an accelerometer, a pressure sensor, a capacitive sensor, a biometric sensor, a magnetometer, a radar unit, a LIDAR unit, an ultrasound unit, a temperature sensor, or any other sensor capable of detecting or determining one or more aspects or conditions of the operational environment of the electronic device 201.

The electronic communication unit 206 can communicate (i.e., receive and transmit) data with one or more external devices or systems, such as charging station 210, using one or more wired or wireless electronic communication protocols, such as radio waves, an 802.11 electronic communication protocol, a Bluetooth electronic communication protocol, a near-field communication (NFC) electronic communication protocol, an infrared (IR) electronic communication protocol, a human-body-conductivity electronic communication protocol, a light modulation electronic communication protocol, a sound modulation electronic communication protocol, a power modulation electronic communication protocol, or the like. Although FIG. 2 shows the electronic communication unit 206 as a single unit, multiple electronic communication units can be used.

The human interface unit 226, or user interface, can output, present, or display data to a user of the electronic device 201, such as data received from the primary battery 204, the data storage unit 224, the processor 222, the sensor unit 220, the electronic communication unit 206, and the charging station 210. For example, the human interface unit 226 can include a light-based display, a sound-based display, a haptic feedback system, a motion-based display, or a combination thereof.

The human interface unit 226 can receive user input and communicate user input data representing the user input to the primary battery 204, the data storage unit 224, the processor 222, the sensor unit 220, the electronic communication unit 206, or a combination thereof. In some examples, the human interface unit 226 can receive one or more signals from the sensor unit 220, and can interpret the sensor signals to receive the user input. The human interface unit 226 can include a light-based user input receiver, such as a camera or infrared receiver, a sound-based receiver, such as a microphone, a mechanical receiver, such as a keyboard, button, joystick, dial, or slider, a switch, a motion-based input, a touch-based input, or a combination thereof.

The system 200 can include one or more auxiliary batteries 208. The auxiliary batteries 208 can be rechargeable batteries, such as lithium-ion polymer batteries. In some examples, the electronic device 201 can include one or more receiving slots to electrically couple with one or more of the auxiliary batteries 208. The auxiliary batteries 208 can removably couple with the electronic device 201 and the charging station 210. The auxiliary batteries 208 can provide power to one or more components of the electronic device 201. In some examples, the auxiliary batteries 208 can be used to charge the primary battery 204. In some examples, the primary battery 204 can charge the auxiliary batteries 208.

The charging station 210 can be operable to modulate the charge of the auxiliary batteries 208 and primary battery 204. The charging station 210 can be substantially similar to, and can include some or all of the features and components of, the charging station 110 discussed above. Further, the components of the charging station 210 can be substantially similar to, and can include some or all of the features and components of, the components of the electronic device 201 discussed above. The charging station 210 can include a housing 212, an electronic communication unit 216, a sensor unit 228, a data processing unit (“processor”) 230, a data storage unit 232, a power supply 214, and a human interface unit 234. The charging station 210 can communicate with the electronic device 201 via communications link 218 or with the cloud service 240 via communications link 238.

In some examples, the electronic device 201 can include receiving elements for receiving one or more batteries, such as the primary batter 204 or the auxiliary batteries 208. The receiving elements can electrically couple a battery with the electrical components of the electronic device 201. The receiving elements can be substantially similar to those discussed above with reference to FIG. 1.

In some examples, the power supply unit 214 can include a receiving element to receive and electrically couple the power supply unit 214 with one or more batteries. The receiving element can be configured to removably couple the charging station 210 with a battery. In some examples, the receiving element can include attachment features that are incorporated into the housing 212 of the charging station 210. The receiving element can be configured as a terminal, recess, slot, latch, groove, notch, magnet or other feature capable of securing and/or electrically coupling one or more batteries with the power supply unit 114 of the charging station 210. In some examples, the receiving element includes an electrical connection such as a wire that connects to a battery without requiring the battery to be attached to, or be in direct contact with, the housing 212 of the charging station 210. In some examples, the charging station 210 charges one or more batteries via inductive charging. The auxiliary batteries 208 can be electrically couplable with the electronic device 101 via electrical coupling 242, and with the charging station 210 via electrical coupling 244.

The charging station 210 can be a stationary or portable device. In some examples, the charging station 210 can be a smart charger. The charging station 210 can implement one or more aspects of the methods and systems described herein. It will be understood that the charging station 210 can include other components not shown in FIG. 2. Further details of operational protocols between wearable and companion devices are provided below with reference to FIG. 2.

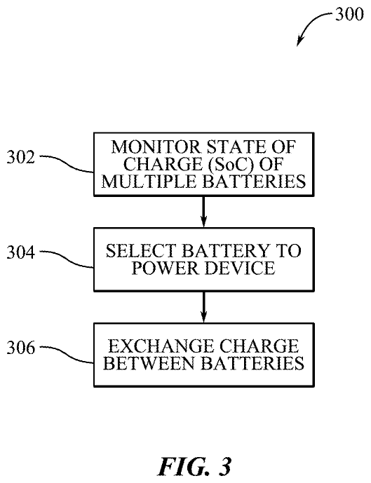

In some examples, the processor 222 is located on-board or disposed in the internal volume of the electronic device 201. The electronic device 201 can make operational decisions for the charging station 210. In some examples, the system 200 could use internet/IOT protocols to connect the electronic device 201 with the charging station 210. In some examples, the charging station 210 makes operational decisions via its processor 230. In some examples, the electronic device 201 and the charging station 210 communicate with a cloud service 240. The cloud service 240 can be associated with a user account. The cloud service 240 can be used as remote processing and data storage means. Further details regarding processes for battery management systems are provided below with reference to FIG. 3.

FIG. 3 shows a process flow diagram 300. The process 300 can be performed using the battery management system 100 or 200 discussed above, or any of the devices or battery management systems described herein. The process 300 can relate to an example in which an electronic device is electrically connected to multiple rechargeable batteries, such as a primary fixed battery and a removable auxiliary battery. At step 302, a state of charge (SoC) of one or more batteries is monitored. In some examples, a processor in the electronic device monitors the respective states of charge of the primary and auxiliary battery. The states of charge can range between a full state of charge (i.e., 100%) to an empty state of charge (i.e., 0%).

At step 304, a processor of the electronic device can select which battery to power the device based on the respective states of charge. The decision of which battery to use can be based on a desire to operate one or both of the batteries in a predetermined range or zone. The desired state of charge can be a range in which the battery experiences minimal degradation while still being able to power the device. For example, a desired state of charge of the batteries can be between 10% and 90%, between 20% and 80%, or between 30% and 70%. According to one example, if the primary battery has a relatively low state of charge (e.g., 20%), the auxiliary battery can be selected to power the device to avoid causing the primary battery from operating outside of a desired zone. According to another example, if the primary battery has a relatively high state of charge (e.g., 100%) and the auxiliary battery has a desired state of charge (e.g., 60%), the primary battery can be selected to obtain a desired state of charge in the primary battery and maintain the desired state of charge in the auxiliary battery. In some examples, the processor can prioritize the health of the primary battery over that of the auxiliary battery. In some examples, the primary battery may have a full state of charge (e.g., 100%) and the device can be plugged in. In this example, the processor can select the primary battery to power the device to reduce trickle charging and degradation of the primary battery. In some examples, the default can be to power the device using the auxiliary battery to avoid degradation of the primary battery.

Selection of the battery to power the device can be based on the power demands of the device. If, for example, the device is in a high power mode (i.e., requiring a large demand of power), the device can be programmed to use the auxiliary battery to power the device. In some examples, the user can select which battery to use. Multiple batteries can be selected to simultaneously power the device. In some examples, the power requirements of the device can be evenly split between the batteries. In some examples, the power requirements of the device are unevenly divided between the available batteries.

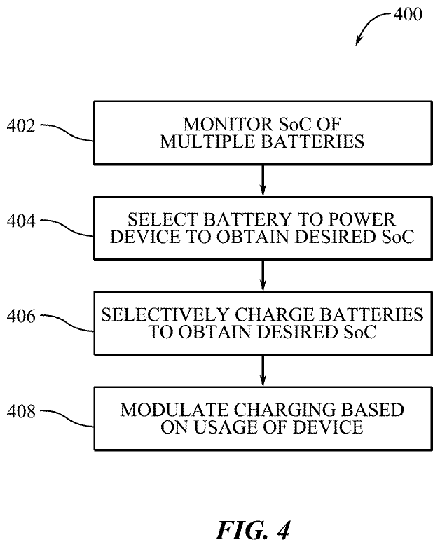

The auxiliary battery can be used to charge the primary battery. For example, the primary battery may have a state of charge outside of the desired zone (e.g., 5%). In response, the auxiliary battery can charge the primary battery to raise the state of charge back into the desired zone (e.g., 80%) or above. In some examples, the device can instruct the auxiliary battery to continuously charge the primary battery. Further details regarding processes for battery management systems are provided below with reference to FIG. 4.

FIG. 4 shows a process flow diagram 400. The process 400 can be performed on a battery management system, such as systems 100 or 200 discussed above, or any of the devices or battery management systems described herein. The process 400 can be substantially similar to, and can include some or all of the features of, the process 300 discussed above. At step 402, the states of charge of multiple batteries can be monitored. Step 402 can be substantially similar to step 302 discussed above. The states of charge can be monitored by the electronic device, the charging station, or both.

At step 404 a battery is selected to power the device. The battery selection can be based on a desire to maintain or obtain a desired state of charge in one or more of the batteries. Step 404 can be substantially similar to step 304 discussed above. At step 406, the batteries are selectively charged to obtain or maintain a desired state of charge in one or more of the batteries. Charging can be done via the charging station, another battery, or an external power supply. For example, the auxiliary battery can be removed from the electronic device and electrically coupled with the charging station. In some examples, selection of which battery to charge can be based on a mode of charging. For example, the system can reserve fast or rapid charging modes for the auxiliary battery, to prevent degradation or a reduction of storage capacity in the primary battery.

At step 408, charging of the batteries can be modulated based on a usage of the device. For example, the batteries can be dynamically charged based on a past, current, or predicted use of the device. The device can learn the user's habits and can make predictions of upcoming power needs based on the learned habits. In some examples, the batteries are dynamically charged based on a power mode of the device or a required power consumption of the device. In some examples, the batteries are dynamically charged based on an upcoming calendar event or email content. For example, if the system determines, from email or calendar events, that the user will likely be at a location with a charger and a power supply readily available (i.e., home or the office), the system can choose to not charge the battery fully. However, if the system determines that the user will likely not have access to a charger or travel supply (e.g., traveling, camping, weekends, etc.) the system can charge the battery to a full state of charge.

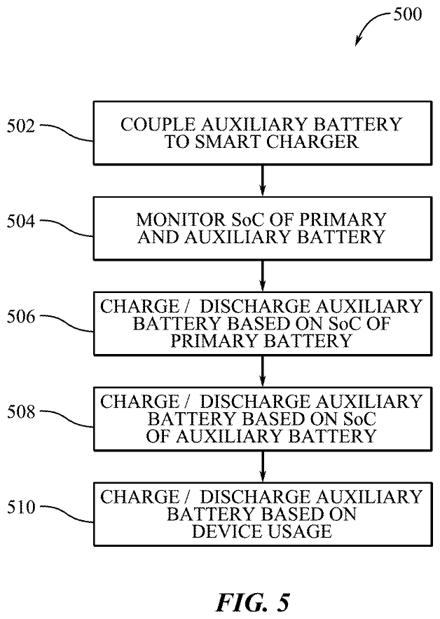

In some examples, the batteries can be dynamically charged based on a GPS location of the device or based on a perceived environment of the user, for example, perceived by an on-board camera. The batteries can be dynamically charged based on conversation topics of the user. The batteries can be dynamically charged based on an alarm set by the user on the device. In some examples, the batteries are dynamically charged based on the date or time. In this manner, one or more batteries can be charged to a full state of charge prior to an anticipated use of the battery. Further, by learning the user's habits, the batteries need not be charged to a full state of charge for a significant period of time prior to use. Battery modulation can also include actively discharging a state of charge of a battery, for example, in order to obtain a desired state of charge. In some examples, the system can actively discharge an auxiliary battery that has a full state of charge if the system determines that the user is not proximate the auxiliary battery and is unlikely to be near the auxiliary battery in the near future (e.g., the user is at work and left the auxiliary battery at home on the charging station). Further details regarding processes for battery management systems are provided below with reference to FIG. 5.

FIG. 5 shows a process flow diagram 500. The process 500 can be performed on a battery management system, such as system 100 or 200 discussed above, or any of the devices or battery management systems described herein. The process 500 can be substantially similar to, and can include some or all of the features of, the processes 300 and 400 discussed above. The process 500 can, according to one example, relate to a primary battery being housed in an electronic device, and an auxiliary battery being coupled to a smart charger. At step 502, an auxiliary battery can be electrically coupled or attached to a smart charger, such as a charging station discussed herein. The smart charger can be operable to charge or discharge the auxiliary battery. At step 504, a state of charge of the primary battery in the electronic device, and the state of charge of the auxiliary battery on the smart charger can be monitored. Step 504 can be substantially similar to steps 302 and 402 discussed above. For example, the states of charge can be monitored by a processor of the device, the smart charger, or both.

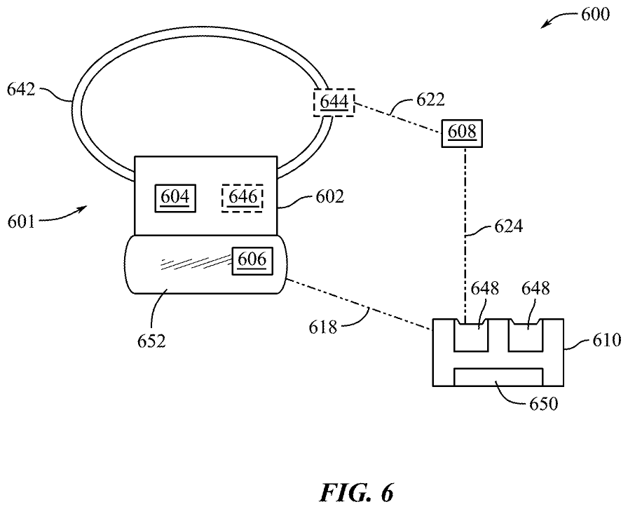

At step 506, the auxiliary battery can be charged or discharged by the smart charger based on a state of charge of the primary battery. At step 508, the auxiliary battery can be charged or discharged based on a state of charge of the auxiliary battery. At step 510, the auxiliary battery can be charged or discharged by the smart charger based on a usage of the device. For example, the auxiliary battery can be dynamically charged by the smart charger based on past, current, or predicted uses of the device. In some examples, the device can learn the user's habits and can make predictions of upcoming power needs based on the learned habits. In some examples, the auxiliary battery can be dynamically charged based on a power mode of the device or required power consumption of the device. In some examples, the auxiliary battery can be dynamically charged based on an upcoming calendar event or timer. In some examples, the auxiliary battery can be dynamically charged based on the date or time. Steps 506, 508, and 510 can be substantially similar to steps 406 and 408 discussed above. Further details regarding battery management systems are provided below with reference to FIG. 6.

FIG. 6 shows a battery management system 600. The battery management system 600 can be substantially similar to, and can include some or all of the features of, the systems 100 and 200 discussed above. The system 600 can be operable to perform the processes 300, 400, or 500 discussed above. The system 600 can include a wearable device 601, an auxiliary battery 608, and a charging station 610. In some examples, the wearable device 601 can be a head-mounted display for use in virtual reality, mixed reality, augmented reality, augmented virtuality, or computer-generated reality. The head-mounted display 601 can be substantially similar to, and can include some or all of the features of, the electronic devices 101 and 201 discussed above. The head-mounted display 601 can include a housing 602, a display or lens 652, a primary battery 604, one or more receiving elements 646 for an auxiliary battery 608, and a retaining element 642.

The auxiliary battery 608 can be received by, and can be electrically couplable with, the head-mounted display 601 via electrical coupling 622. For example, the electrical coupling 622 can occur between the receiving element 644 and the auxiliary battery 608, or between the receiving element 646 and the auxiliary battery 608. The auxiliary battery 608 can be received by, and can be electrically couplable with, the charging station 610 via electrical coupling or retaining element 642.

The head-mounted display 601 can include an outward or external-facing sensor 606. The external-facing sensor 606 can detect or determine one or more aspects of the physical environment of the head-mounted display 601. The external-facing sensor 606 can include one or more of a camera, a microphone, an infrared receiver, a global positioning system unit, a gyroscopic sensor, an accelerometer, a pressure sensor, a capacitive sensor, a biometric sensor, a magnetometer, a radar unit, a LIDAR unit, an ultrasound unit, a temperature sensor, or any other sensor capable of detecting or determining one or more aspects or conditions of the environment of the head-mounted display 601.

The housing 602 of the head-mounted display 601 can be a physical structure that incorporates, contains, or connects electrical components such as the primary battery 604, the auxiliary battery 608, and other electrical components such as those discussed above with reference to FIG. 2. The wearable device 601 can include a display 652 that can present images visible to the user or visible to others on an exterior of the wearable device 601. In some examples, the display 652 can include a transparent or semi-transparent lens for the user to view the outside environment. In some examples, battery characteristics can be displayed to the user on the display 652. For example, the display 652 can present a dynamic image representing the battery life or state of charge of a particular battery. The display 652 can display a battery life indicator for the primary battery and an indicator for the auxiliary battery. The display 652 can indicate which battery is currently powering the device. The display 652 can also provide prompts or recommendations to the user, such as a prompt to recharge a battery, to attach a battery, to unplug the device, or to switch which battery is powering the device 601. The wearable device 601 can be communicatively coupled to various electronic devices. In some examples, the wearable device 601 can include a vision system operable to determine a gaze of the user and identify an object of interest of the user. In some examples, the display 652 can display to the user characteristics of an electronic device that is in the field of view of the wearable device 601. For example, the display 652 can present a battery life or state of charge of an electronic device that the user is looking at, even if the device is locked or closed. Further, in some examples, the user can look at the charging station 610 to prompt auxiliary and primary battery state of charge indicators to display in the wearable device 601.

The wearable device 601 can include a primary battery 604. The primary battery 604 can be a rechargeable battery and can be permanently or removably attached to the housing 602. It will be understood that some users may choose to keep the wearable device 601 constantly plugged in to a power supply. In response, the user can set the device 601 into a “kiosk” mode in which the batteries remain at a desired state of charge (e.g., 40%-60%). The display 652 can indicate to the user that the device 601 is in such a mode. The kiosk mode can be set by the user or can automatically be set by the device 601.

The system 600 can include an auxiliary battery 608. Although only one auxiliary battery 608 is shown, it will be understood that multiple auxiliary batteries could be used in the same or similar manner described herein. The auxiliary battery 608 can be a rechargeable battery, such as lithium-ion polymer battery. In some examples, the wearable device 601 can include one or more receiving elements or slots 646 to electrically couple the wearable device with the auxiliary battery 608. In some examples, the receiving element 646 is an electrical connection such as a wire that can connect to the auxiliary battery 608 without requiring that the auxiliary battery is attached to or in direct contact with the wearable device 601. For example, the auxiliary battery 608 can be electrically coupled to the wearable device 601 via a wire, such that the user could place the auxiliary battery 608 in a clothing pocket or backpack while wearing the wearable device 601. The auxiliary battery 608 can removably couple with the wearable device 601 and the charging station 610. The auxiliary battery 608 can provide power to one or more components of the wearable device 601. In some examples, the auxiliary battery 608 can be used to charge the primary battery 604. In some examples, the primary battery 604 can charge the auxiliary batteries 208. The retention element 642 can be a band, strap, frame, helmet, hat, or other securing feature to mount the head-mounted display 601 on a user's head. In some examples, the retention element 642 can include a receiving element 644 for the auxiliary battery 608. In some examples, the receiving element 644 is used to hold the auxiliary battery 608. In some examples, the receiving element 644 includes electrical terminals to electrically couple with the auxiliary battery 608. In some examples, the retention element 642 can include electrical wires to transfer power between the auxiliary battery 608 and the head-mounted display 601.

The charging station 610 can be substantially similar to, and can include some or all of the features of, the charging stations 110 and 210 discussed above. The charging station 610 can include one or more receiving elements for electrically coupling with one or more batteries, such as auxiliary battery 608, and a receiving element 650 for electrically coupling with the head-mounted display 601 and the primary battery 604. In some examples, the primary battery 604 can be removable from the housing 602 and can be charged via the receiving elements 648. In some examples, the receiving element 650 can be configured to couple with at least a portion of the housing 602 or display 652 of the head-mounted display 601. In some examples, the head-mounted display 601 can be communicatively coupled through a communications link 618 with the charging station 610 via one or more electronic communication protocols.

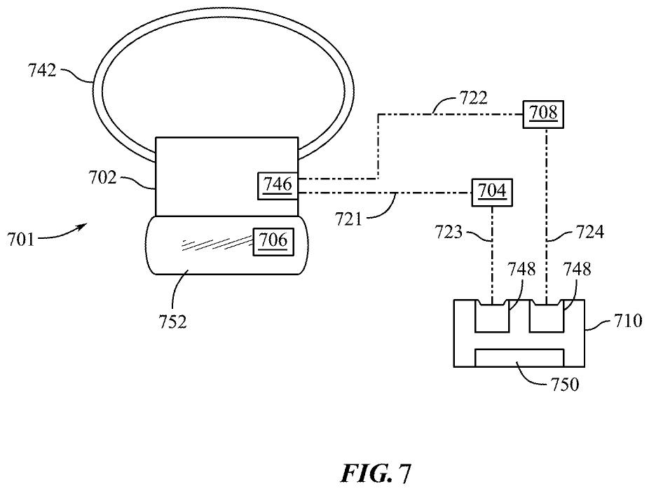

FIG. 7 shows a block diagram of a battery management system 700. The battery management system 700 can be substantially similar to, and can include some or all of the features of, the system 600 discussed above. The system 700 can be operable to perform the processes 300, 400, or 500 discussed above. The system 700 can include a wearable device 701, a second battery 708, and a charging station 710. In some examples, the wearable device 701 can be a head-mounted display for use in virtual reality, mixed reality, augmented reality, augmented virtuality, or computer-generated reality. The head-mounted display 701 can be substantially similar to, and can include some or all of the features of, the head-mounted display 601 discussed above. The head-mounted display 701 can include a housing 702, a display or lens 752, one or more receiving elements 746 for a first battery 704 and/or a second battery 708, and a retaining element 742.

The first battery 704 can be different from the second battery 708. For example, the second battery 708 can be larger or have a higher capacity than the first battery 704, or vice versa. The first battery 704 and the second battery 708 can be received by, and can be electrically couplable with, the head-mounted display 701 via electrical coupling 721 and 722, respectively. For example, the electrical couplings 721 and 722 can occur between the receiving element 746 and the first battery 704 and the second battery 708, respectively. The first battery 704 and the second battery 708 can be received by and can be electrically couplable with the charging station 710 via electrical couplings 723 and 724, respectively.

The head-mounted display 701 can include an outward or external-facing sensor 706. The external-facing sensor 706 can detect or determine one or more aspects of the physical environment of the head-mounted display 701. The external-facing sensor 706 can include one or more of a camera, a microphone, an infrared receiver, a global positioning system unit, a gyroscopic sensor, an accelerometer, a pressure sensor, a capacitive sensor, a biometric sensor, a magnetometer, a radar unit, a LIDAR unit, an ultrasound unit, a temperature sensor, or any other sensor capable of detecting or determining one or more aspects or conditions of the environment of the head-mounted display 701.

The housing 702 of the head-mounted display 701 can be a physical structure that incorporates, contains, or connects electrical components, such as the first battery 704 and the second battery 708, and other electrical components such as those discussed above with reference to FIG. 2. The wearable device 701 can include a display 752 that can present images visible to the user or visible to others on an exterior of the wearable device 701. In some examples, the display 752 can include a transparent or semi-transparent lens for the user to view the outside environment. In some examples, battery characteristics can be displayed to the user on the display 752. For example, the display 752 can present a dynamic image representing the battery life or state of charge of a particular battery. The display 752 can display a battery life indicator for the first battery 704 and an indicator for the second battery 708. The display 752 can indicate which battery is currently powering the device. The display 752 can also provide prompts or recommendations to the user, such as a prompt to recharge a battery, to attach a battery, to unplug the device, or to switch which battery is powering the device 701. The wearable device 701 can be communicatively coupled to various electronic devices. In some examples, the wearable device 701 can include a vision system operable to determine a gaze of the user and identify an object of interest of the user. In some examples, the display 752 can display to the user characteristics of an electronic device that is in the field of view of the wearable device 701. For example, the display 752 can present a battery life or state of charge of an electronic device that the user is looking at, even if the device is locked or closed. Further, in some examples, the user can look at the charging station 710 to prompt battery state of charge indicators to display in the wearable device 701.

The first battery 704 and the second battery 708 can be rechargeable, such as lithium-ion polymer battery. In some examples, the wearable device 701 can include one or more receiving elements or slots 746 to electrically couple the wearable device with the first battery 704 and the second battery 708. In some examples, the receiving element 746 is an electrical connection such as a wire that can connect to the first battery 704 and the second battery 708 without requiring that the first or second batteries 704, 708 be attached to or in direct contact with the wearable device 701. For example, the first battery 704 and the second battery 708 can be electrically coupled to the wearable device 701 via a wire, such that the user could place the first battery 704 or the second battery 708 in a clothing pocket or backpack while wearing the wearable device 701. The first battery 704 and the second battery 708 can removably couple with the wearable device 701 and the charging station 710. The first battery 704 and the second battery 708 can provide power to one or more components of the wearable device 701. In some examples, the first battery 704 and the second battery 708 can be used to charge one another. The retention element 742 can be a band, strap, frame, helmet, hat or other securing feature to mount the head-mounted display 701 on a user's head.

The charging station 710 can be substantially similar to, and can include some or all of the features of, the charging stations 110, 210, and 610 discussed above. The charging station 710 can include one or more receiving elements for electrically coupling with one or more batteries, such as first battery 704 and second battery 708, and a receiving element 750 for electrically coupling with the head-mounted display 701. In some examples, the first battery 704 and the second battery 708 can be removable or detachable from the housing 702 and can be charged via the receiving elements 748. In some examples, the receiving element 750 can be configured to couple with at least a portion of the housing 702 or display 752 of the head-mounted display 701.

Personal information data, gathered pursuant to authorized and well established secure privacy policies and practices that are appropriate for the type of data collected, can be used to implement and improve on the various embodiments described herein. The disclosed technology is not, however, rendered inoperable in the absence of such personal information data.

It will be understood that the details of the present systems and methods above can be combined in various combinations and with alternative components. The scope of the present systems and methods will be further understood by the following claims.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

As used herein, a physical environment includes a physical world that can be sensed or interacted with without electronic systems. In contrast, as used herein, a computer-generated reality can include a simulated environment, to any degree, that people sense and/or interact with using an electronic system, including virtual reality and mixed reality. Similarly, virtual reality can refer to a simulated environment that is designed to be based entirely on computer-generated sensory inputs for one or more senses. In contrast, mixed reality environments refer to a simulated environment that is designed to incorporate sensory inputs from the physical environment, or a representation thereof, in addition to including virtual objects. These environments can be generated using any number of hardware components including, but in no way limited to, head mounted systems, projection-based systems, heads-up displays, mobile phones, windshields with integrated displays, speakers, headphones, tablets, laptop computers, monitors, televisions, displays of all types, and the like.

What is claimed is:

1. A battery management system, comprising:
an electronic device comprising a primary battery;
an auxiliary battery electrically couplable with the electronic device; and
a charging station, comprising:
a power supply;
a receiving element to receive and electrically couple with at least one of the primary battery or the auxiliary battery; and
an electronic communication unit to communicate with the electronic device;
the charging station configured to modulate a state of charge of at least one of the primary battery or the auxiliary battery based on at least one of the state of charge of the primary battery, the state of charge of the auxiliary battery, or a usage of the electronic device.

2. The battery management system of claim 1, wherein the electronic device comprises a head-mounted display, the head-mounted display comprising:
a housing defining an internal volume;
a processor disposed in the internal volume and in communication with the charging station, the processor operable to monitor a state of charge of the primary battery and a state of charge of the auxiliary battery;
wherein the primary battery is a fixed battery disposed in the internal volume, and the auxiliary battery is removably attachable to the electronic device.

3. The battery management system of claim 2, wherein the processor is configured to maximize a duration that the primary battery has a desired state of charge by modulating the state of charge of the primary battery and the state of charge of the auxiliary battery.

4. The battery management system of claim 3, wherein the desired stated of charge is between 20% and 80%.

5. The battery management system of claim 3, wherein the processor modulates the state of charge of the primary battery by causing the primary battery to power the electronic device in response to the primary battery exceeding the desired state of charge.

6. The battery management system of claim 3, wherein the processor modulates the state of charge of the auxiliary battery by causing the auxiliary battery to power the electronic device in response to the primary battery having the desired state of charge.

7. The battery management system of claim 1, wherein the usage of the electronic device comprises at least one of a calendar event, a location of the electronic device, a power consumption, a proximity of the auxiliary battery, a time of day, or a date.

8. The battery management system of claim 1, wherein the auxiliary battery comprises a first auxiliary battery and the battery management system further comprises a second auxiliary battery, the second auxiliary battery electrically couplable with the electronic device to:
power the electronic device;
charge the primary battery; and
charge the auxiliary battery.

9. The battery management system of claim 1, wherein the primary battery charges the auxiliary battery when the auxiliary battery and the primary battery are electrically coupled with the electronic device.

10. The battery management system of claim 2, wherein the auxiliary battery powers the electronic device in response to the electronic device being in a high power mode.

11. The battery management system of claim 1, wherein the charging station modulates a rate of charge of the auxiliary battery based on a rate of discharge of the primary battery when the primary battery is electrically coupled with the electronic device.

12. The battery management system of claim 1, wherein the charging station prioritizes a rapid charge of the auxiliary battery over a rapid charge of the primary battery.

13. A battery management system comprising:
an auxiliary battery electrically couplable with an electronic device, the electronic device comprising a primary battery;
a charging station, comprising:
a receiving element to receive and electrically couple with the auxiliary battery; and
an electronic communication unit to communicate with the electronic device;
the charging station configured to modulate a state of charge of the auxiliary battery based on at least one of a state of charge of the primary battery, a state of charge of the auxiliary battery, or a usage of the electronic device.

14. The battery management system of claim 13, wherein the charging station transmits a signal to the electronic device corresponding to the state of charge of the auxiliary battery.

15. The battery management system of claim 13, wherein the charging station maintains the state of charge of the auxiliary battery in a desired range when the auxiliary battery is electrically coupled with the charging station.

16. The battery management system of claim 13, wherein:
the electronic device is electrically couplable with the charging station; and
the state of charge of the primary battery is modulated by the charging station.

17. A head-mounted display, comprising:
a head mounting component;
a housing defining an internal volume;
a display component;
an external-facing sensor;
an electronic communication unit to communicate with a charging station;
a primary battery; and
a processor disposed in the internal volume, the processor operable to modulate a state of charge of the primary battery and a state of charge of an auxiliary battery electrically coupled with the charging station based on at least one of the state of charge of the primary battery, the state of charge of the auxiliary battery, or a usage of the head-mounted display.

18. The head-mounted display of claim 17, further comprising a receiving element to receive and electrically couple with the auxiliary battery.

19. The head-mounted display of claim 18, wherein the primary battery is removably connected to the receiving element.

20. The head-mounted display of claim 17, wherein the usage of the head-mounted display comprises at least one of a calendar event, a location of the head-mounted display, a current power consumption, a typical power consumption, a proximity of the auxiliary battery, a time of day, or a date.
